(19) United States
(12) Patent Application Publication
(10) Pub. No.: US 2021/0037045 A1
(43) Pub. Date: Feb. 4, 2021

(54) SYSTEM AND METHOD FOR CYBER-SECURE COMMUNICATIONS

(71) Applicant: ABB Schweiz AG, Baden (CH)

(72) Inventor: Karl Eric Harper, Cary, NC (US)

(21) Appl. No.: 16/527,874

(22) Filed: Jul. 31, 2019

(51) Int. Cl. H04L 29/06

(52) U.S. Cl. CPC H04L 63/1441; H04L 63/123; H04L 69/22

(57) ABSTRACT

Cyber security for a communications network can be enhanced with benchmarking, logging, and monitoring message transfer latencies between nodes to detect any changes in equipment or configuration due to unauthorized surveillance. In addition, the transfer of the messages between nodes is provided with cyber attack mitigation measures to be able to maintain operations even if encryption is compromised.

### FIELD OF THE INVENTION

The present disclosure relates to cyber security, and in particular to a system and method providing secure communications over a communication network.

### BACKGROUND

Communications for monitoring and control of transmission and distribution power grids are typically conducted over hardwired connections within the substation and back to the utility offices. Industrial processing plants and other critical infrastructure have similar communications between components close to the physical plant connected to manufacturing and supervisory management and control. These high-speed links are private and protected by physical security to prevent unauthorized access. Perimeter defense of communications can also be provided using network firewalls to enhance security from cyber attacks.

The addition of distributed energy resources (DER) to the transmission and distribution grids requires the scope of the monitoring and control to extend outside the substation, which makes perimeter defense less effective. The addition of edge computing and distributed process control have a similar impact on critical infrastructure. While the development of wireless mesh communication systems such as 5G provides a cost effective solution for network communications between DERs and other types of resources, these systems are subject to eavesdropping, surveillance, and possible attack from malicious actors.

One technique to mitigate cyber attacks and unwanted surveillance involves encryption of the messages sent via the communication network, but even encryption can be ineffective if the cryptography is compromised or human mistakes expose the credentials or keys. Therefore, there remains a substantial need for the unique architectures, apparatuses, methods, systems and techniques disclosed herein.

### SUMMARY

Exemplary embodiments of the disclosure include unique systems, methods, techniques and apparatuses for providing communications between a source node and a destination node that are secure from cyber attacks and unauthorized surveillance. Further embodiments, forms, objects, features, advantages, aspects and benefits of the disclosure shall become apparent from the following description and drawings.

### BRIEF DESCRIPTION OF THE DRAWINGS

FIG. 1A is a schematic of a system including a communication network.

FIG. 1B is an example of a message fragment transmittable over the communication network of FIG. 1A.

FIG. 2 is a schematic of one embodiment of a controller for the communication network.

FIG. 3 is a flow diagram of a procedure establishing a circuit between the source node an the destination node for transmission of messages over the communication network.

FIG. 4 is a flow diagrams of procedures for secure transmission of messages over a communication network.

FIG. 5 is a flow diagram of a procedure assembling the message at the destination node.

FIG. 6 is a flow diagram of another procedure for secure transmission of messages over a communication network.

FIG. 7 is a flow diagram of another procedure for one-way secure transmission of messages over a communication network.

FIGS. 8A and 8B include a flow diagram of another procedure for bi-directional secure transmission of messages over a communication network.

### DETAILED DESCRIPTION

For the purposes of clearly, concisely and exactly describing illustrative embodiments of the present disclosure, the manner and process of making and using the same, and to enable the practice, making and use of the same, reference will now be made to certain exemplary embodiments, including those illustrated in the figures, and specific language will be used to describe the same. It shall nevertheless be understood that no limitation of the scope of the invention is thereby created, and that the invention includes and protects such alterations, modifications, and further applications of the exemplary embodiments as would occur to one skilled in the art.

The present disclosure relates to architectures, apparatuses, methods, systems and techniques for providing secure communications between two or more nodes of a communication network associated with a system of resources. In one embodiment, the communications network is associated with an electric power system, such as a transmission and/or distribution grid including DERs, and each of the nodes represents at least one resource of the electric power system connected to the grid. However, the communications network may also be associated with other types of systems including interconnected resources, such as industrial control systems, Internet of Things, and access control systems, for example.

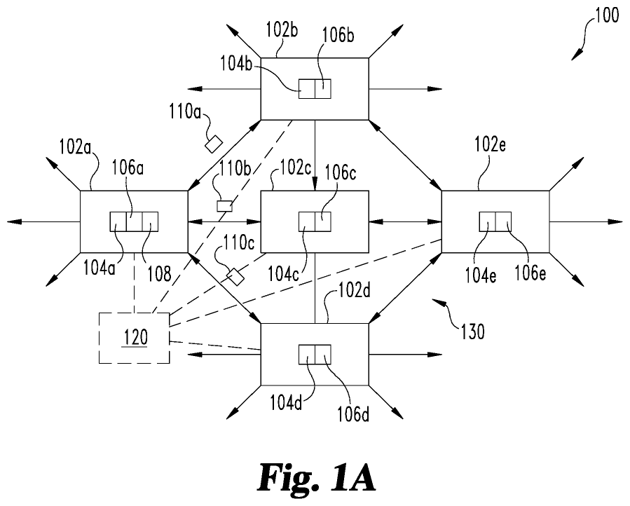

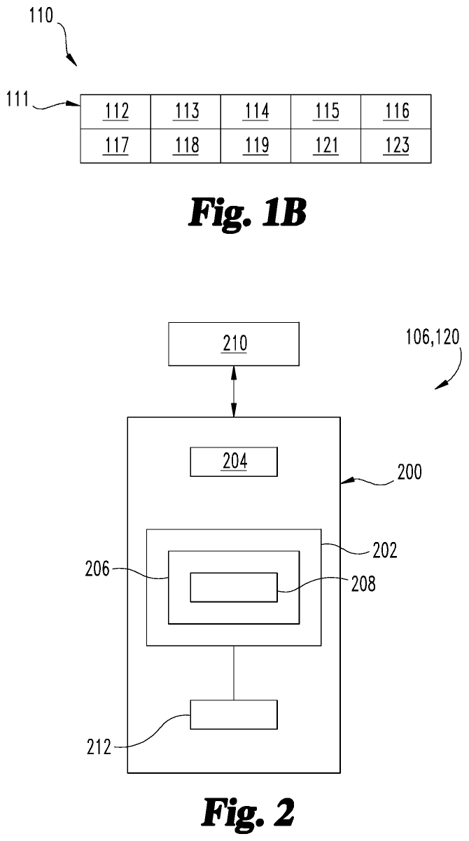

A system 100 is shown in FIG. 1A which includes a plurality of nodes 102a, 102b, 102c, 102d, 102e that each include at least one resource 104a, 104b, 104c, 104d, 104e, respectively, connected in a network 130. Each node 102a, 102b, 102c, 102d, 102e includes at least one local controller 106a, 106b, 106c, 106d, 106e, respectively, configured with a transmitter, receiver, or transceiver for sending and receiving signals between nodes 102, which signals may include one or more messages 108. Nodes 102a, 102b, 102c, 102d, 102e may also be referred to collectively and individually herein as a node or nodes 102; resources 104a, 104b, 104c, 104d, 104e may be collectively and individually referred to herein as resource or resources 104; and controllers 106a, 106b, 106c, 106d, 106e may also be referred to collectively and individually herein as a controller or controllers 106. A centralized controller 120 can also be provided that is in communication with the nodes 102 and/or each of the resources 104, although a centralized controller is not required. It should be understood that any number of nodes 102 and any number of resources 104 resources are contemplated to form the network. In addition, different numbers and types of resources 104 can be provided within each node 102.

The present disclosure includes the secure transmission of messages between the nodes 102 to, for example, manage the operation of system 100. A variety of resources 104 may be connected on network 130 and act together to provide a service or perform a function. Network 130 can be wired, wireless, a combination of wired or wireless, and use any suitable communication protocol to transmit messages between nodes 102 and, if provided, a centralized network controller 120. The present disclosure provides a robust solution for node-to-node communication among distributed resources 104 which is secure against cyber attacks and undesired surveillance, and that can be routed around compromised nodes.

Resources 104 may include, for example, a substation, a transformer, a circuit breaker, a switch, a sensor, an intelligent electrical device (IED), and/or a DER. An IED may refer to or include any intelligent electrical device, such as, for example, any one or combination of a central processing unit (CPU), a CPU-based relay and/or protective relay, a communication processor, a digital fault recorder, a generic data collector, a phasor measurement unit (PMU), a phasor measurement and control unit (PMCU), a phasor data concentrator (PDC), a power quality meter (PQM), a protection IED, a switch controller, a relay with phasor measurement capabilities, a Supervisory Control and Data Acquisition (SCADA) system, or any other device or system capable of communicating in an electrical power system or other system of networked resources. The DER may include a combined heat and power plant, a photovoltaic (PV) array, a wind turbine, an electric vehicle, a battery energy storage system, a flywheel, a diesel generator, a home energy management system, or a building energy management system, to name but a few examples.

Each node 102 in system 100 includes a common set of encoded instructions such as a program stored in a memory of and executable by its controller 106 to manage the secure transmission of messages 108 to a destination node along a node path comprising one or more intermediate nodes and possibly the source node. The controller 106a of a first or source node 102a is configured to shard, partition or otherwise divide the message 108 into a plurality of message fragments 110a, 110b, 110c (also individually and collectively referred to as message fragment or fragments 110) before transmission to a controller 106e at a second or destination node 102e.

The message fragments 110 can be sent by the source node 102a to the destination node 102e through and/or along a circuit that includes one or more randomly selected routes comprising one or more intermediate nodes 102 that are regularly changed to deter surveillance and attack. For example, possible routes for the message fragments 110a, 110b, 110c in FIG. 1A include a first node path 102a-102b-102e; a second node path 102a-102c-102e; a third node path 102a-102d-102e; a fourth node path 102a-102b-102c-102d-102e; a fifth node path 102a-102b-102c-102e; 102a-102c-102d-102e; and so on. Any number of randomly generated and select routes are possible using node paths defined by the intermediate nodes 102. The source node 102a can also be included in the route as a node in the node path, and an intermediate node may be used two or more times as a node in a node path. The message fragments 110 can also be sent to the network controller 120 in addition to the destination node 102e, and/or to multiple destination nodes 102e. It should be understood that the number of routes and the number of message fragments can be any number or arrangement, and are not limited to the specific examples shown herein.

Referring to FIG. 1B, each message fragment 110 may include a message header 111 with embedded information such as, for example, a circuit identification 112, a fragment identifier 113 identifying the fragment for assembly at the destination node 102e, a time stamp 114, and a sequence identification or number 115 to identify the associated message number within the lifetime of the current circuit. Each message fragment 110 may also include message data 117 associated with the content of message 110, but one or more message fragments 110 may be provided without message data 117 or with random content to further enhance security. The message header 111 can also include one or more flags that identify the message type, such as a “Request” flag 116 indicating the message is a request to another node or nodes 102, or a “Reply” flag 118 indicating the message is a reply to another node or nodes 102. Another flag 119 could indicate the message data is a “Checksum” for the original content, sent on multiple routes or node paths for reliability. In addition, a flag 121 could indicate the message data is a “Policy” for the message structure, message fragmentation, and/or message assembly, also routed on multiple routes or node paths. The message fragment may also include a “Cleanup” flag 123 such as may be provided with a control message that is transmitted from node-to-node to indicate the use of a circuit is complete. Other flags are also possible in addition to or instead of those discussed herein.

A “Policy” as used herein is an agreement between the source node 102a and the destination node 102e regarding various aspects of the message 108. For example, the “Policy” or policy flag refers to a shared secret about message structure such as where the message content is located within the message fragment 110. In one specific example, the message content, flags, message length, etc. could be moved to different fields or locations within the message structure depending on the policy flag. The number of message fragments 110 and allocation of message data 117 among the message fragments 110 that are created from the message 108 can be varied according to policy over different time periods, where all messages in a time period use the same construction. Furthermore, the amount of message data 117 in each message fragment 110 can vary from message fragment to message fragment. One example of a fragmentation policy for the message data 117 could be to place a different quantity or bytes of message data 117 sliced from the original message, along with the fragment identifiers 113, into the various message fragments 110 at the source node 102a. In a further embodiment, some of the message fragments 110, such as every other one, every third one, etc., may be provided without message data 117 or with random content. The message data 117 can be provided as a variable length buffer or other suitable form. The fragments 110 can be composed by the destination node 102e using the fragment identifiers 113 to reconstruct the content of the message 108 for each sequence number 115.

In operation, any receiving node 102 can authenticate the identification of the respective sending node 102 in the node path in one hop, although the use of multiple hops is not precluded. A map of node identifiers to access points can be protected within the network 130 to keep access points anonymous. The network 130 can also provide authority for globally unique circuit identifications 112 for the routes along which the message fragments 110 are transmitted. Security can be enhanced since no map needs to be maintained for the various circuit identifications 112, allowing the message fragments 110 to remain anonymous. The authority for the sending node 102 allows for the monotonic increase in sequence numbers 115 uniquely within a circuit. The sequence number 115 can be incremented by one for each collection of message fragments 110 and/or each message 108 to defend against a replay attack.

The routes for transmission of the message fragments 110 between the source and destination nodes 102a, 102e can be cleared or cleaned up and synced with control messages sent by the source node 102a that resemble message fragments 110. Attempts to surveil an intermediate node (sending and receiving nodes 102b, 102c, 102d or other node upstream of the destination node 102e) will be frustrated by incomplete information in the message fragment 110, and by the lack of circuit information about the route or node path used for transmission of the message fragment 110 other than the adjacent sending and receiving nodes 102. Attempts to change messages 108 with man-in-the-middle (MITM) or other types of intercept attacks will be prevented because the message fragments 110 of a message 108 traverse different routes and are incomplete.

In operation, any node 102 can be a source node 102a with information to share with other nodes 102 via a message 108. The source node 102a can transmit an event identification to the subscriber nodes 102b, 102c, 102d, 102e according to a publisher-subscriber architecture among the nodes 102. The subscriber nodes 102b, 102c, 102d, 102e are authenticated directly by the source node 102a as the publisher. Each event is associated with a unique identifier that is used by the subscriber nodes 102b, 102c, 102d, 102e to request the associated message 108 from the source node 102a within a pre-determined amount of time; otherwise the event is timed out and the request is deemed invalid. Control messages are transmitted in a similar way between nodes 102. For example, the source node 102a can transmit a control message to subscriber nodes requesting identification of any pending control actions. The required handshake, sequence number, and timeout for acting on the request prevents replay attempts by a malicious actor.

All messages 108 can be encrypted, but frequent control communication between nodes 102 and the splitting of messages 108 into message fragments 110 allows the message content to be hidden even if encryption is compromised. In addition, node-to-node communication latencies can be baselined, and then verified for each transfer of a message fragment 110. If an actual transfer latency deviates from the baseline or nominal transfer latency, this could provide an indication of an attempted attack at the node due to, for example, additional code being injected at the node, redirected processing in the runtime, or a MITM attack. If a node 102 is determined to be compromised, then the compromised node can be unsubscribed by the other nodes and is no longer included in randomly generated node paths used for communication of the message fragments 110, effectively routing the message fragments 110 around the damaged or compromised node.

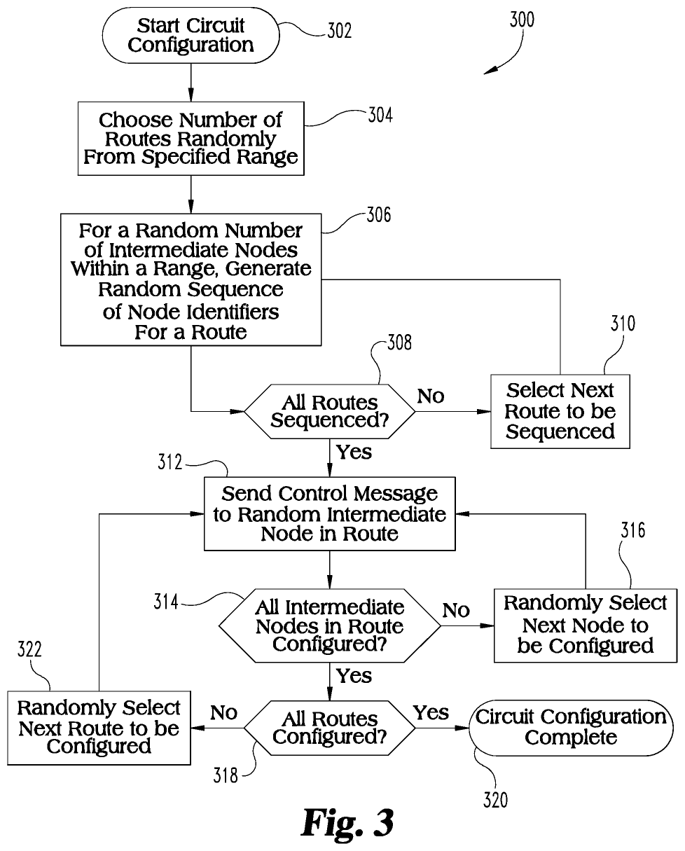

In FIG. 2 there is a schematic block diagram of an exemplary controller 200 such as may be provided as a local controller 106 at each of the nodes 102 and/or network controller 120 of system 100 in FIG. 1A. Controller 200 may include a processing device 202, an input/output device 204, a memory device 206, and operating logic 208. Furthermore, the controller 200 communicates with one or more other controllers 200 of an external device 210 such as other nodes 102 and/or network resource controller 120. Controller 200 may be a stand-alone device, an embedded system, or a plurality of devices structured to perform the functions described with respect to system 100.

Input/output device 204 enables controller 200 to communicate with other local controllers or a central controller. Input/output device 204 may include a network adapter, network credential, interface, or a port (e.g., a USB port, serial port, parallel port, an analog port, a digital port, VGA, DVI, HDMI, FireWire, CAT 5, Ethernet, fiber, or any other type of port or interface), to name but a few examples. Input/output device 204 may include more than one of these adapters, credentials, or ports, such as a first port for receiving data and a second port for transmitting data.

Processing device 202 may include one or multiple processors, Arithmetic-Logic Units (ALUs), Central Processing Units (CPUs), Digital Signal Processors (DSPs), or Field-programmable Gate Arrays (FPGAs), to name but a few examples. For forms of processing devices with multiple processing units, distributed, pipelined, or parallel processing may be used. Processing device 202 may be dedicated to performance of only the operations described herein or may be used in one or more additional applications. Processing device 202 may be of a programmable variety that executes algorithms and processes data in accordance with operating logic 208 as defined by programming instructions (such as software or firmware) stored in memory device 206. Alternatively or additionally, operating logic 208 for processing device 202 is at least partially defined by hardwired logic or other hardware. Processing device 202 may comprise one or more components of any type suitable to process the signals received from input/output device 204 or elsewhere, and provide desired output signals. Such components may include digital circuitry, analog circuitry, or a combination of both.

Memory device 206, also known as a computer readable medium, may be of one or more types of memory, such as a solid-state variety, electromagnetic variety, optical variety, or a combination of these forms, to name but a few examples. Furthermore, memory device 206 may be volatile, nonvolatile, transitory, non-transitory or a combination of these types, and some or all of memory device 206 may be of a portable variety, such as a disk, tape, memory stick, or cartridge, to name but a few examples. In addition, memory device 206 may store data that is manipulated by operating logic 208 of processing device 202, such as data representative of signals received from and/or sent to input/output device 204 in addition to or in lieu of storing programming instructions defining operating logic 208, just to name one example. Memory device 206 may be included with processing device 202 and/or coupled to processing device 202 as indicated by an external memory 212.

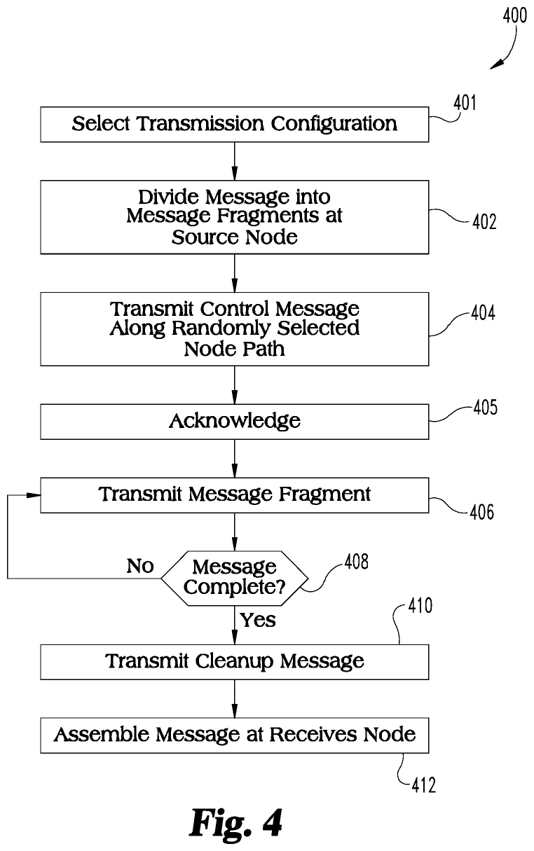

An embodiment of a procedure 300 in FIG. 3 is provided for establishing a circuit between the source node 102a and the destination node 102e for transmission of messages 110 over the communication network 130 of system 100. Procedure 300 starts at 302 to establish a circuit configuration for transmission of the message fragments 110. A circuit is a composition of multiple routes of intermediate nodes 102 between the source node 102a and the destination node 102e. Procedure 300 includes an operation 304 to choose the number of routes within the circuit randomly from a specified number or range of routes for a circuit according to a policy for circuit establishment. The destination node 102e does not need to know the number of routes chosen. The policy can establish the number of routes in a circuit, or a range of routes in a circuit, such as a minimum number and maximum number of routes in a circuit.

Procedure 300 continues at operation 306 to, for a random number of intermediate nodes within a range, generate a random sequence of node identifiers for the specified route in the circuit based on a policy. The destination node 102e does not need to know either the number of intermediate nodes in a route nor the node paths. Policies can be agreed upon by the nodes 102 in advance and can be set using an index or flag. For example, the policy can establish the number of intermediate nodes in each route, or a range of intermediate nodes in the route, such as a minimum number and maximum number of intermediate nodes in the route.

Procedure 300 continues at conditional 308 to determine if all routes in the circuit are sequenced or configured. If conditional 308 is NO, procedure continues at operation 310 to select the next route to be sequenced or configured, and then returns to operation 306 to generate the random sequence of node identifiers for configuration of the selected route.

If conditional 308 is YES, procedure 300 continues at operation 312 to send a control message to a random intermediate node in the route. The control message configures the intermediate node to associate a sending node (immediately upstream of the intermediate node) and a receiving node (immediately downstream of the intermediate node) with a circuit identification 112. Procedure 300 continues at conditional 314 to determine if all intermediate nodes in the route are configured. If conditional 314 is NO, procedure 300 continues at operation 316 to randomly select the next node in the route to be configured, and then returns to operation 312 to send a control message to the next randomly selected intermediate node of the route.

If conditional 314 is YES, procedure 300 continues at conditional 318 to determine if all routes of the circuit are configured. If conditional 318 is NO, continues at operation 322 to randomly select the next route to be configured, and then returns to operation 312 to send a control message to the next randomly selected intermediate node of the route. If conditional 318 is YES, the circuit configuration is complete at 320.

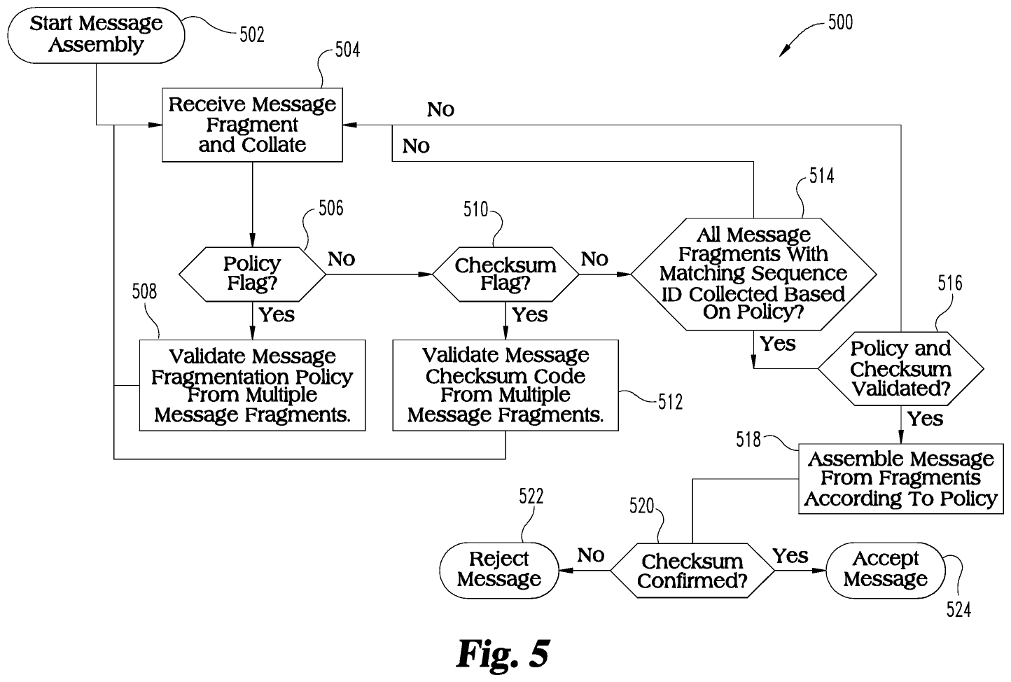

An embodiment of a procedure 400 in FIG. 4 is shown for cyber secure communications between a source node 102a and a destination node 102e using the circuit configured according to procedure 300. Procedure 400 starts with an operation 401 to randomly select a transmission configuration for the message from several fragmentation policies. Procedure 400 then iterates an operation 402 that divides each message 108 into the transmission configuration according to a selected fragmentation policy to create a plurality of message fragments 110 at a first one of a plurality of nodes, such as the source node 102a. Each message fragment 110 can include, for example, a circuit identification, a fragment identifier, a timestamp, a sequence number and flag as discussed above. The message fragments also may or may not include a part of the message content.

Splitting the message 108 into the plurality of message fragments 110 can include placing bytes or parts of the message in only a portion of the plurality message fragments 110. The procedure 400 can also include a “Ping” operation 404 to transmit or send a control message from the source node 102a along a randomly selected route to verify the sending node and the receiving node for each of the plurality of intermediate nodes 102 along the route or node path. The destination node 102e can then set up the necessary circuit, like the one configured by the source node 102a, to send return messages and respond with an acknowledge or “Ack” 405 operation. This enables reliable bi-directional communication rather than simple one-way between source and destination nodes 102a, 102e.

Procedure 400 continues at operation 406 to transmit the respective message fragment 110 from the source node 102a to the destination node 102e along randomly selected route formed by the node path of the one or more of the plurality of nodes 102a, 102b, 102c, 102d from the source node 102a to the destination node 102e. Procedure 400 continues at conditional 408 to determine if message transmission is complete. If conditional 408 is NO, procedure 400 returns to operation 404 if a route is to be selected. If not procedure 400 could return to operation 406 to transmit another message fragment.

If conditional 408 is YES, the circuit can remain valid for a period of time to transmit additional messages using the same circuit identification. The circuit can be removed when the circuit is no longer needed or time has expired for using the circuit. Procedure 400 continues at operation 410 to transmit a cleanup message indicating to the nodes 102 associated with the message transmittal that the circuit is no longer needed.

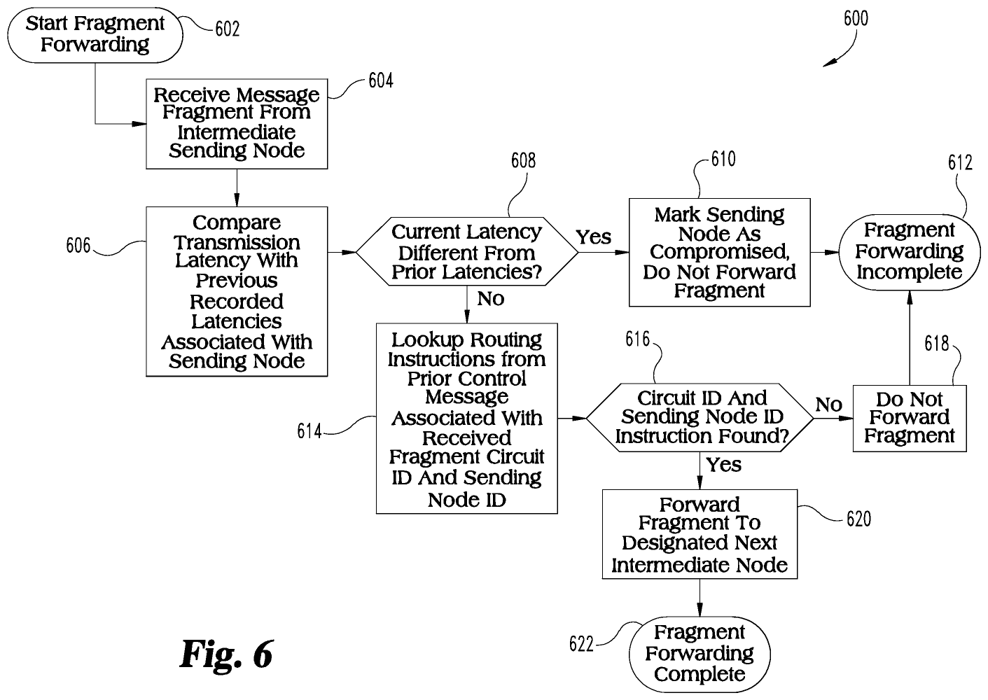

Procedure 400 continues at operation 412 to assemble the plurality of message fragments 110 into the message 108 at the destination node 102e. An embodiment procedure for assembling the message fragments at the destination node 102e is discussed further below with respect to FIG. 5.

The procedure 400 can be employed in a network in which the nodes 102 are subscribed to one another in a publisher-subscriber architecture. The method 400 can include publishing a unique event identifier for an event by the source node 102a that is sent to each of the plurality of nodes 102 subscribed to the source node 102a. The plurality of subscriber nodes 102 can request information about the event in the form of message 108 in response to the unique event identifier that is received by the subscribed nodes. The unique event identifier can be configured to expire after passage of a period of time.

In another embodiment, procedure 400 includes determining a baseline latency in node-to-node communication among the plurality of nodes 102. One or more the nodes 102 along the node paths can be determined to be compromised in response to a deviation of an actual latency of the node-to-node communication from the baseline latency in node-to-node communication by more than a threshold amount of time and/or for a deviation that occurs over a threshold number of occurrences.

FIG. 5 includes an embodiment of a procedure 500 to start message assembly at 502. Procedure 500 continues at operation 504 to receive message fragment 110 at the destination node 102e and collate the message fragment 110 according to policy based on the circuit identification 112 that identifies the circuit that is being used for transmission of messages 108 during the current time period, the message sequence number 115 identifying the particular message 108 being transmitted within the current circuit, and the message fragment identifier 113 identifying the particular message fragment 110 of the particular message 108 that is being transmitted.

Procedure 500 continues at conditional 506 to determine whether the message fragment 110 includes a policy flag for message fragmentation. If conditional 506 is YES, procedure 500 continues at operation 508 to validate the message fragmentation policy from multiple message fragments 110, and return to operation 504 to continue to receive and collate message fragments.

If conditional 506 is NO, procedure 500 continues at conditional 510 to determine if there is a checksum flag in the message fragment 108. If conditional 510 is YES, procedure 500 continues at operation 512 to validate the checksum code from multiple message fragments, and return to operation 504 to continue to receive and collate message fragments 110.

If conditional 510 is NO, procedure 500 continues at conditional 514 to determine if all message fragments 110 with matching sequence numbers for the identified circuit have been collected based on fragmentation policy. If conditional 514 is NO, procedure returns to operation 504 to continue to receive and collate message fragments 110. If conditional 514 is YES, procedure 500 continues at conditional 516 to determine if the policy and checksum are validated the message fragments. If conditional 516 is NO, procedure returns to operation 504 to continue to receive and collate message fragments 110.

If conditional 516 is YES, procedure 500 continues at operation 518 to assemble the message 108 from the message fragments 110 according to policy and fragment identifiers having the same circuit identification and sequence number. The message assembly policy can require, for example, a timeout for receiving the message fragments, the receipt of the same message fragment from different routes, and/or agreement among the message fragments that are received from different routes. Procedure 500 continues at conditional 520 to determine if the checksum is confirmed. If conditional 520 is NO, the message is rejected at 522. If conditional 520 is YES, the message 108 is accepted at 524. If there is an error in the message receipt, the message assembly, message validation, or some other issue in the message transmission, or due to a policy such as a timeout, the establishment of a new circuit can be initiated.

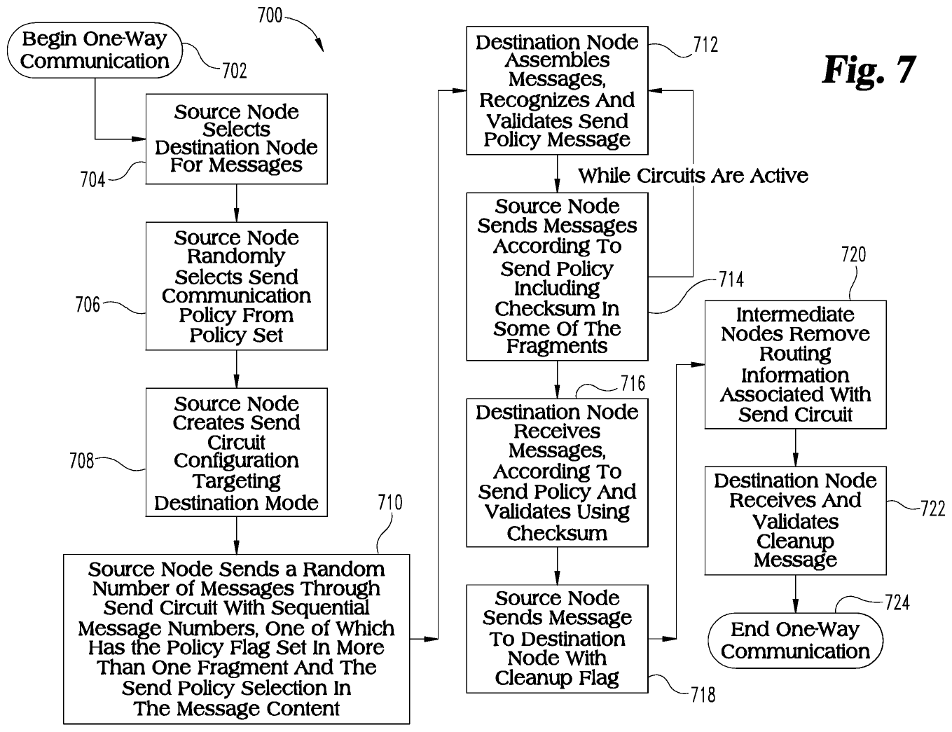

A procedure 600 is shown in FIG. 6 for managing the transmission of messages 108 from a sending node to a receiving node according to the present disclosure. As used herein, the sending node and the receiving node are directly connected nodes in which the message fragment 110 is transmitted in a single hop. Other nodes can be connected indirectly through one or more intermediary nodes. Procedure 600 starts at operation 602, where the message fragment forwarding is initiated from the sending node. At operation 604 the receiving node 102 receives the message fragment 110 from the intermediate sending node.

Procedure 600 continues at operation 606 to compare the transmission latency for the message fragment with previously recorded latencies associated with the sending node. Conditional 608 determines if the current latency is different from the prior latencies associated with the sending node. If conditional 608 is YES, procedure 600 continues at operation 610 to mark the sending node as compromised and the message fragment 110 is not forwarded. Procedure 600 then ends at 612 where the message fragment forwarding is ended and determined to be incomplete. Determining the deviation of the current transmission latency with prior latencies be made using any suitable technique, such as requiring a deviation by more than a threshold amount, a deviation that occurs more than a predetermined number of times, and combinations of these, just to name a few examples.

If conditional 608 is NO, procedure 600 continues at operation 614 to look up routing instructions provided to the receiving node from the prior control message associated with the received circuit identification and sending node identification. Procedure 600 continues at conditional 616 to determine if the circuit identification and sending node identification are found.

If conditional 616 is NO, procedure 600 continues at operation 618 to not forward the message fragment and the message fragment forwarding ends at 612. If conditional 616 is YES, the procedure 600 continues at operation 620 to forward the message fragment to the next designated intermediate node that was established by the control message. From operation 620 procedure 600 ends at 622 where message fragment forwarding is complete.

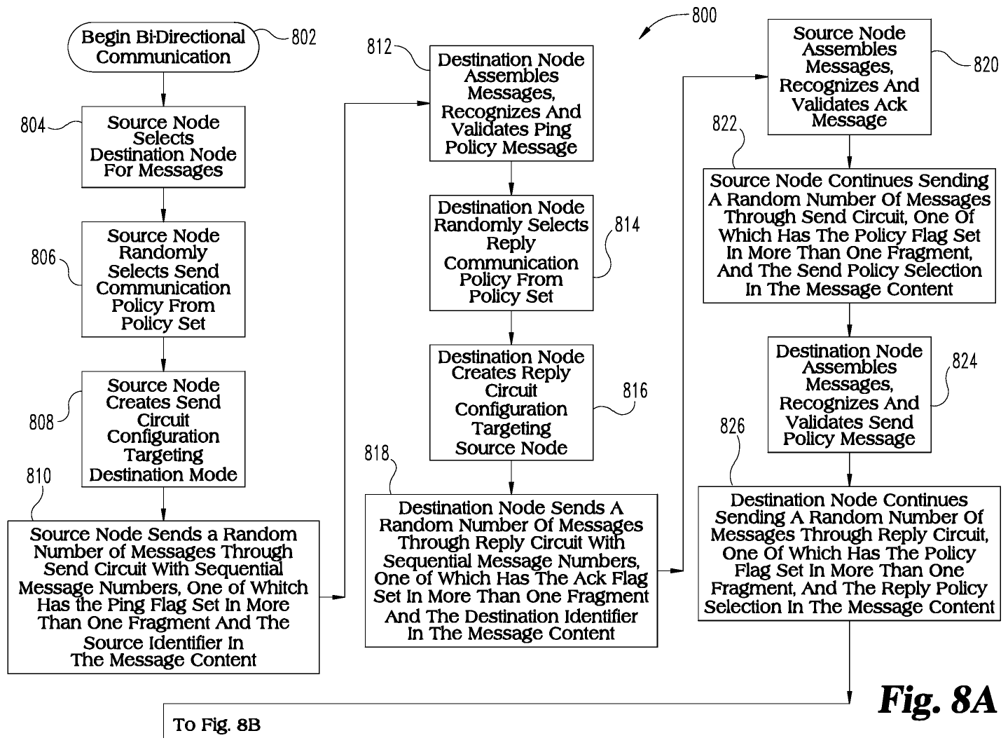

FIG. 7 shows an embodiment of a procedure 700 for one-way communication from the source node 102a to the destination node 102e. Procedure 700 begins the one-way communication at 702, and continues at an operation 704 in which the source node 102a selects the destination node 102e to receive one or more messages 108. At operation 706 source node 102a randomly selects a send communication policy from a policy set. At operation 708 source node 102a creates a send circuit configuration targeting the destination node 102e.

Procedure 700 continues at operation 710 in which the source node 102a sends a random number of messages 108 through the send circuit with sequential message numbers. One of the messages 108 has the policy flag set in one or more message fragments 110, and the send policy selection is provided in the message content. At operation 712 the destination node 102e assembles the messages 108 from the message fragments 110, and recognizes and validates the send policy message. While the circuit is active, procedure 700 continues at operation 714 where the source node 102a sends messages 108 according the send policy via message fragments 110. A checksum can be provided in some of the message fragments 110.

Procedure 700 continues at operation 716 in which the destination node 716 receives messages according to the send policy and validates using the checksum. When use of the circuit for message transmission is complete, procedure 700 continues at operation 718 in which the source node 102a sends a message to the destination node 102e with a cleanup flag. In response to the message with the cleanup flag being received, the intermediate nodes 102 remove therefrom routing information associated with the circuit at operation 720. At operation 722, the destination node 102e receives and validates the cleanup message and the one-way communication is ended at 724.

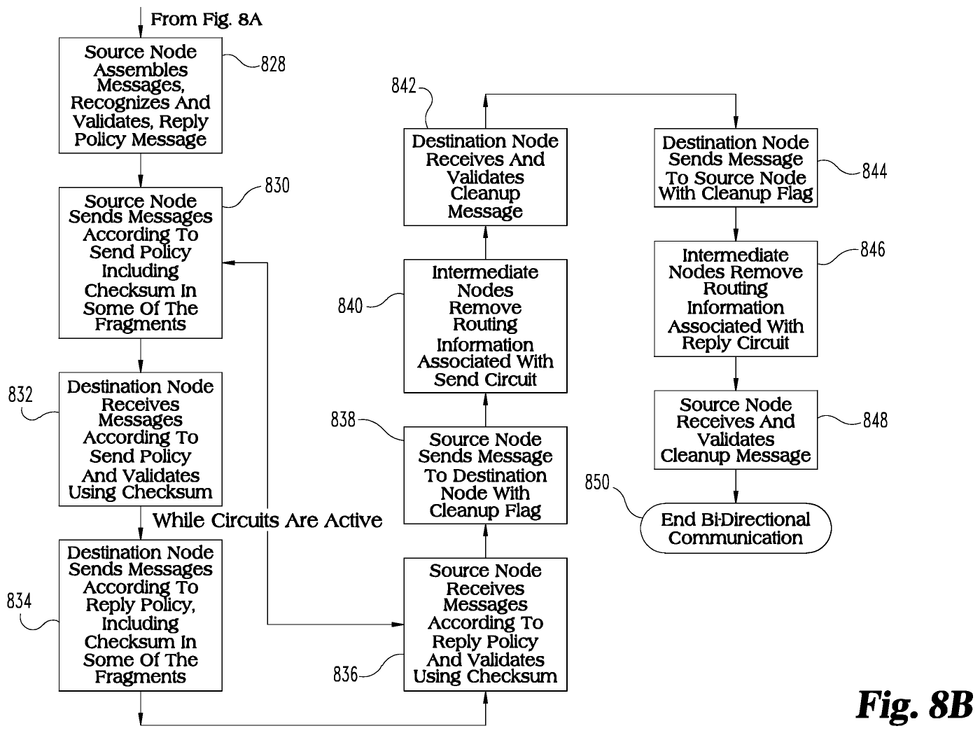

FIGS. 8A and 8B show an embodiment of a procedure 800 for two-way communication from the source node 102a to the destination node 102e. Procedure 800 begins the two-way communication at 802, and continues at an operation 804 in which the source node 102a selects the destination node 102e to receive one or more messages 108. At operation 806 source node 102a randomly selects a send communication policy from a policy set. At operation 808 source node 102a creates a send circuit configuration targeting the destination node 102e.

Procedure 800 continues at operation 810 in which the source node 102a sends a random number of messages 108 through the send circuit with sequential message numbers. One of the messages 108 includes a ping flag set in one or more message fragments 110 and the source identifier in the message content. Procedure 800 continues at operation 812 in which the destination node 102 assembles the messages 108 from the message contents, and recognizes and validates the ping policy message in response to the message with the ping flag set.

Procedure 800 continues at operation 814 in which the destination node 102e randomly selects a reply communication policy from a policy set. At operation 816 the destination node 102e creates a reply circuit configuration targeting the source node 102a. Procedure 800 continues at operation 818 in which the destination node 102e sends a random number of messages through the reply circuit with sequential message numbers. One of the messages has the “Ack” flag set in one or more message fragments and the destination node identifier in the message content.

Procedure 800 continues at operation 820 in which the source node 102a assembles the messages, and recognizes and validates the “Ack” message. At operation 822 the source node 102a continues sending a random number of messages through the send circuit. One of the messages has the policy flag set in more than one message fragment, and the second policy selection is provided in the message content. At operation 824 the destination node 102e assembles the messages and recognizes and validates the send policy message.

Procedure 800 continues at operation 826 in which the destination node continues sending a random number of messages through the reply circuit. At least one of the messages has the policy flag set in one or more fragments, and the reply policy selection is provided in the message content. At operation 828 the source node 102a assembles the messages from the destination node 102e, and recognizes and validates the reply message policy.

At operation 830, and while the circuits are active, the source node 102a sends messages according to the send policy that include checksum in some of the message fragments. At operation 832 the destination node 102e receives the messages according to the send policy and validates using the checksum. In addition, at operation 834 the destination node 102e sends messages according to the reply policy that include checksum in some of the message fragments. At operation 836 the source node 102a receives the messages according to the reply policy and validates using the checksum.

Procedure 800 continues at operation 838 where source node 102a sends a message to the destination node 102e with a cleanup flag. In response to the message with the cleanup flag being received, the intermediate nodes 102 remove therefrom routing information associated with the send circuit at operation 840. At operation 842, the destination node 102e receives and validates the cleanup message. At operation 844 the destination node 102e sends a message to the source node 102a with a cleanup flag. In response to the message with the cleanup flag being received, the intermediate nodes 102 remove therefrom routing information associated with the reply circuit at operation 846. At operation 848, the source node 102a receives and validates the cleanup message and the one-way communication is ended at 850.

There are several applications that can benefit from the present disclosure. For example, a power grid with DERs can be monitored and the operators reliably know that the associated messages 108 have not been surveilled or modified. Identifying and stopping surveillance such as through the message fragmentation, random node path selection, and latency deviation monitoring discussed herein reduces the possibility of follow-on attack coordination. The monitoring of message transfer latencies at each node 102 can be a local early warning system to identify changes in configuration and possible damage at the node, allowing a node to mark itself as compromised. Changes in latency are difficult to sustain, making it less likely to be used as a denial of service attack. Nodes 102 can also collaborate with each other to optimize local operations to maintain power grid quality and reduce energy costs.

Compromising encryption any single intermediate node 102 in the network 130 will reveal little information to the attacker because messages 108 are split into the message fragments 110 and compartmentalized in separate, potentially redundant circuits. The circuits defined by the various routes or node paths for transmitting the message fragments 110 can be rearranged on a frequent basis so if an attacker determines one configuration for the route, the solution will not be sustainable. In addition, as communication networks further develop, such as with 5G low latency and high bandwidth communications, there are a cacophony of messages generated where the data hides in the noise of the frequent control messages. Finally, monitoring the node-to-node communication latencies provides an early warning system alerting to active surveillance or attack.

The techniques described in the present application can be implemented, demonstrated, and/or tested at the application layer (layer 7) or the data link layer (layer 2) of the Open Systems Interconnection (OSI) seven layer model. The application layer is an abstraction layer closest to the end user that specifies the shared communications protocols and interface methods used by the nodes 102 in the network 130. The application layer and the user/resource interact directly with a software application to implement the communication of messages 108 between nodes 102. The application layer functions can include identifying nodes 102 and synchronizing communication between nodes 102, even if the nodes 102 have different communication protocols.

Implementation of the present disclosure at the data link layer can be employed in the design of a new mesh network fabric, reducing even further the potential for corruption and compromise. The data link layer provides a framework for the reliable transmission of data between two directly and physically connected nodes 102. The data link layer defines the protocol to establish and terminate a connection between two physically connected nodes 102, and also the protocol for flow control between the nodes 102. Examples of connections at the data link layers include Ethernet, Wi-Fi, Zigbee, Point-to-Point Protocol (PPP), and high speed local area networking over existing wires (power lines, phone lines, and coaxial cables, for example.)

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

According one aspect of the present disclosure a system for cyber secure communications is provided. The system includes a source node configured to divide a message into a plurality of message fragments. Each message fragment includes at least a circuit identification of a circuit for a transmission of the message fragments, a sequence number for the message within the circuit, a fragment identifier for each message fragment, and a policy identification for a policy for assembling the message fragments. The system also includes a destination node configured to assemble the message fragments into the message based on the policy identification, the sequence number, and the fragment identifier. The system further includes plurality of routes associated with the circuit identification. The plurality of routes is each formed by a plurality of nodes that are connected directly or indirectly to the destination node, where different ones of the plurality of routes associated with the circuit identification are randomly selected for transmission of the plurality of message fragments from the source node to the destination node.

In one embodiment, the destination node is configured to create a reply circuit for transmission of a reply message targeted to the source node, divide the reply message into a plurality of reply message fragments, and transmit the plurality of reply message fragments along one or more routes of the reply circuit to the source node for assembly by the source node. In another embodiment, the source node is configured to send a cleanup message to the destination node and the plurality of nodes along the plurality of routes remove routing information therefrom in response to the cleanup message. In yet another embodiment, only a part of the plurality message fragments includes message data.

In another embodiment, the source node is configured to send a control message to each of the plurality of nodes along each of the plurality of routes to identify a sending node and a receiving node for each of the nodes along the associated route. In yet another embodiment, in response to a deviation from a baseline latency in node-to-node communication involving at least one of the plurality of nodes, the at least one of the plurality of nodes is removed from the plurality of routes in a subsequently created circuit.

In another embodiment, at least part of the plurality of message fragments include a message header containing the circuit identification, the sequence number, the fragment identifier, one or more flags, message content length, and message content. In a refinement of this embodiment, the one or more flags include at least one of a request flag, a reply flag, a checksum flag, a policy flag, and a cleanup flag.

In another embodiment, of the plurality of message fragments is validated according at least one of a policy flag and a checksum. In a further embodiment, the source node, the destination node, and the plurality of nodes are different parts of a communications network for an electric power system.

According to another aspect of the present disclosure, a method for cyber secure communications includes: dividing a message into a plurality of message fragments at a first one of a plurality of nodes, where each message fragment includes at least a circuit identification of a circuit for transmission of the message fragments, a message assembly policy identification, a sequence number for the message within the circuit, and a fragment identifier for the message fragment; transmitting each of the message fragments from the first one of the plurality of nodes to a second one of the plurality of nodes along a randomly selected one of a plurality of routes associated with the circuit identification, each of the routes being formed by at least a part of the plurality of nodes; and assembling the plurality of message fragments into the message at the second one of the plurality of nodes based on the message assembly policy identification, the sequence number, and the fragment identifier.

In one embodiment, the method includes creating a reply circuit with the destination node for transmission of a reply message targeted to the source node; dividing the reply message into a plurality of reply message fragments; and transmitting the plurality of reply message fragments along one or more routes of the reply circuit to the source node for assembly by the source node.

In another embodiment, dividing the message into the plurality of message fragments includes placing message data in only a portion of the plurality message fragments. In yet another embodiment, the method includes sending a control message from the first one of the plurality of nodes to each of the plurality of nodes to identify a sending node and a receiving node to each node for each route of a circuit associated with the circuit identification. In still another embodiment, the method includes configuring a circuit associate with the circuit identification by randomly selecting a number of routes for the circuit from a specified range and selecting a random number of nodes and a sequence of nodes for each route in the circuit.

In another embodiment, the method includes determining a baseline latency in node-to-node communication among the plurality of nodes and removing one of the plurality of nodes from the plurality of node paths in response to a deviation of an actual latency from the baseline latency in node-to-node communication. In yet another embodiment, the method includes validating each of the message fragments according to at least one of a message fragmentation policy and a checksum.

In another embodiment, the method includes determining all message fragments including a matching sequence number are collected before assembling the plurality of message fragments based on the fragment identifiers of the plurality of message fragment. In another embodiment, at least part of the plurality of message fragments include a message header containing the circuit identification, the sequence number, the fragment identifier, one or more flags, message content length, and message content. In another embodiment, the one or more flags include at least one of a request flag, a reply flag, a checksum flag, a policy flag, and a cleanup flag.

While the present disclosure has been illustrated and described in detail in the drawings and foregoing description, the same is to be considered as illustrative and not restrictive in character, it being understood that only certain exemplary embodiments have been shown and described, and that all changes and modifications that come within the spirit of the present disclosure are desired to be protected. It should be understood that while the use of words such as “preferable,” “preferably,” “preferred” or “more preferred” utilized in the description above indicate that the feature so described may be more desirable, it nonetheless may not be necessary, and embodiments lacking the same may be contemplated as within the scope of the present disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. The term “of” may connote an association with, or a connection to, another item, as well as a belonging to, or a connection with, the other item as informed by the context in which it is used. The terms “coupled to,” “coupled with” and the like include indirect connection and coupling, and further include but do not require a direct coupling or connection unless expressly indicated to the contrary. When the language “at least a portion” and/or “a portion” is used, the item can include a portion and/or the entire item unless specifically stated to the contrary.

I claim:

1. A system for cyber secure communications, comprising:
a source node configured to divide a message into a plurality of message fragments, wherein each message fragment includes at least a circuit identification of a circuit for a transmission of the message fragments, a sequence number for the message within the circuit, a fragment identifier for each message fragment, and a policy identification for assembling the message fragments;
a destination node configured to assemble the message fragments into the message based on the policy identification, the sequence number, and the fragment identifier; and
a plurality of routes associated with the circuit identification, wherein the plurality of routes is each formed by a plurality of nodes that are connected directly or indirectly to the destination node, wherein different ones of the plurality of routes associated with the circuit identification are randomly selected for transmission of the plurality of message fragments from the source node to the destination node.

2. The system of claim 1, wherein the destination node is configured to create a reply circuit for transmission of a reply message targeted to the source node, divide the reply message into a plurality of reply message fragments, and transmit the plurality of reply message fragments along one or more routes of the reply circuit to the source node for assembly by the source node.

3. The system of claim 1, wherein the source node is configured to send a cleanup message to the destination node and the plurality of nodes along the plurality of routes remove routing information therefrom in response to the cleanup message.

4. The system of claim 1, wherein only a part of the plurality message fragments includes message data.

5. The system of claim 1, wherein the source node is configured to send a control message to each of the plurality of nodes along each of the plurality of routes to identify a sending node and a receiving node for each of the nodes along the associated route.

6. The system of claim 1, wherein, in response to a deviation from a baseline latency in node-to-node communication involving at least one of the plurality of nodes, the at least one of the plurality of nodes is removed from the plurality of routes.

7. The system of claim 1, wherein at least part of the plurality of message fragments include a message header containing the circuit identification, the sequence number, the fragment identifier, one or more flags, message content length, and message content.

8. The system of claim 7, wherein the one or more flags include at least one of a request flag, a reply flag, a checksum flag, a policy flag, and a cleanup flag.

9. The system of claim 1, wherein each of the plurality of message fragments is validated according at least one of a policy flag and a checksum.

10. The system of claim 1, wherein the source node, the destination node, and the plurality of nodes are different parts of a communications network for an electric power system.

11. A method for cyber secure communications, comprising:
dividing a message into a plurality of message fragments at a first one of a plurality of nodes, wherein each message fragment includes at least a circuit identification of a circuit for transmission of the message fragments, a message assembly policy identification, a sequence number for the message within the circuit, and a fragment identifier for the message fragment;
transmitting each of the message fragments from the first one of the plurality of nodes to a second one of the plurality of nodes along a randomly selected one of a plurality of routes associated with the circuit identification, each of the routes being formed by at least a part of the plurality of nodes; and
assembling the plurality of message fragments into the message at the second one of the plurality of nodes based on the message assembly policy identification, the sequence number, and the fragment identifier.

12. The method of claim 11, further comprising:
creating a reply circuit with the destination node for transmission of a reply message targeted to the source node;
dividing the reply message into a plurality of reply message fragments; and
transmitting the plurality of reply message fragments along one or more routes of the reply circuit to the source node for assembly by the source node.

13. The method of claim 11, wherein dividing the message into the plurality of message fragments includes placing message data in only a portion of the plurality message fragments.

14. The method of claim 11, further comprising sending a control message from the first one of the plurality of nodes to each of the plurality of nodes to identify a sending node and a receiving node to each node for each route of a circuit associated with the circuit identification.

15. The method of claim 11, further comprising configuring a circuit associate with the circuit identification by randomly selecting a number of routes for the circuit from a specified range and selecting a random number of nodes and a sequence of nodes for each route in the circuit.

16. The method of claim 11, further comprising determining a baseline latency in node-to-node communication among the plurality of nodes and removing one of the plurality of nodes from the plurality of node paths in response to a deviation of an actual latency from the baseline latency in node-to-node communication.

17. The method of claim 11, further comprising validating each of the message fragments according to at least one of a message fragmentation policy and a checksum.

18. The method of claim 11, further comprising determining all message fragments including a matching sequence number are collected before assembling the plurality of message fragments based on the fragment identifiers of the plurality of message fragment.

19. The method of claim 11, wherein at least part of the plurality of message fragments include a message header containing the circuit identification, the sequence number, the fragment identifier, one or more flags, message content length, and message content.

20. The method of claim 19, wherein the one or more flags include at least one of a request flag, a reply flag, a checksum flag, a policy flag, and a cleanup flag.
